(19) United States
(12) Patent Application Publication
(10) Pub. No.: US 2013/0305897 A1
(43) Pub. Date: Nov. 21, 2013

(54) Adjustable Magnetic Guitar or Similar Stringed Instrument Support

(71) Applicant: Kristopher Charles Barnett, Atlanta, GA (US)

(72) Inventor: Kristopher Charles Barnett, Atlanta, GA (US)

(21) Appl. No.: 13/868,691

(22) Filed: Apr. 23, 2013

Related U.S. Application Data
(63) Continuation-in-part of application No. 13/276,317, filed on Oct. 18, 2011, now Pat. No. 8,455,744.

(51) Int. Cl. G10G 5/00

(52) U.S. Cl. CPC G10G 5/005
USPC 84/327

(57) ABSTRACT

An improved adjustable stringed instrument apparatus, hereafter known as ‘support’, ‘instrument support’ or ‘guitar support’, that supports the instrument in playing position while the user is in the sitting position. The support attaches to the instrument using magnets and rests on the user's leg. It utilizes a leg rest connected via an adjustable support with a magnet housing at each end of the leg rest. This instrument support has several unique benefits over suction cup-type supports such as secure and reliable attachment to the instrument, non-marring attachment components, and the ability to be attached to a variety of imperfect surfaces and shapes. In addition, magnets have the unique ability to allow location of the support repeatedly at the exact desired location when it is secured to the instrument. Three discrete mechanisms on the support allow for vertical, horizontal, and angular adjustments of the instrument. The support's design allows it to be easily attached, removed, adjusted, collapsed, and stored. Several additional embodiments of the invention are also described and illustrated.

### PRIOR ART AND BRIEF SUMMARY OF THE INVENTION

There have been several designs for an apparatus that supports a guitar or similar stringed instrument while in a seated playing position (U.S. Pat. Nos. 7,732,689; 7,205,468; 6,252,150; 6,005,175; 4,966,062 and 3,979,993). The current invention implements novel and improved mechanisms for both adjusting the instrument's position vis-à-vis the player and the means for attaching the support to the instrument.

An object of this invention is to provide a novel instrument support that can be securely attached to any acoustic guitar or like instrument regardless of the instrument's finished surface. Previous designs implemented plastic or rubber suction cups that do not adhere well to curved, recessed, worn, damaged, porous, delicate, oily, or otherwise imperfect surfaces (U.S. Pat. Nos. 7,205,468; 6,252,150; 6,005,175; 4,966,062). It is also well established that these attachment means can be deleterious to various finishes commonly found on stringed instruments such as lacquer and shellac. Furthermore, such contacting means require periodic replacement as their usefulness as an attachment mechanism decreases in time due to wear and/or material breakdown.

Other designs use an apparatus that supports the instrument from underneath but is not directly or securely attached to it (U.S. Pat. Nos. 7,732,689 and 3,979,993). The Support cushion (U.S. Pat. No. 3,979,993) is limited in both its adjustability and ease of storage, while the Foldable support (U.S. Pat. No. 7,732,689) only allows for vertical adjustment and not horizontal or angular adjustments. Further disadvantages of existing designs have been noted by Jiang & Yan (U.S. Pat. No. 7,732,689).

The current support alleviates the above mentioned issues by implementing magnets as the attachment means to the instrument and three discrete mechanisms for vertical, horizontal, and angular adjustments. Magnets or magnetic material attached to the support member attract magnets or magnetic material installed on or in the body of the instrument. Magnetic attraction is the mechanism by which the instrument support attaches to the instrument.

Substituting magnetic material (e.g. rare earth magnets) for suction cups allows the support to be smaller, more versatile, and have greater adjustability than previous suction cup-type supports. The size of the support is decreased and is thus more portable due to the relatively small size of the magnets needed for attaching the support to the instrument. The reduced footprint also increases versatility as the support can be attached to instruments that are too thin for suction-type supports. The strength of the magnets also improves adjustability as the magnets can withstand adjustments that would cause other attachment mechanisms to fail.

Magnets are implemented not only as an attachment means but also as a locating mechanism for the support. Magnets have the unique property of attracting other magnets or ferrous material and will “find” the magnets installed on the guitar ensuring consistent and proper placement of the support each time it is used. Setup time is further decreased because the adjustment settings do not need to be changed when collapsing and storing the support.

Three discrete mechanisms allow for vertical, horizontal, and angular adjustments. Vertical adjustments are achieved by adjusting the length of the flexible leg support member. The pivoting magnet housing allows horizontal adjustments while in playing position. These adjustments are made by moving the support longitudinally along the underside of the instrument. This adjustment is possible because the rotating magnet housing will conform to any contour on the underside of the instrument. The adjustable rigid support member allows angular adjustment of the instrument while in playing position. These adjustments are achieved by loosening the securing member and adjusting the overall length of the support.

These objects are achieved by a novel support that comprises a flexible leg support member connected to both an adjustable rigid support member with hinged pivoting magnet housing at one end and a second magnetic member at the other. The instrument support is held in place on the instrument by magnetic attraction or similar fields of a force.

An alternative embodiment of this invention substitutes a curved rigid leg support member for a flexible leg support member. A second adjustable rigid support member is implemented for greater versatility and adjustability. Furthermore, the leg support member rotates on an axis and rests flat on the player's leg to further increase comfort for the player. A toothed clutch mechanism holds the rotating leg support member in the desired position and adjustments are made by disengaging the toothed clutch and rotating the leg support member about an axis. Several mechanisms can be implemented to ensure proper engagement and disengagement of the clutch such as a spring or screw mechanism.

This summary is not intended to exhaust all possible embodiments of the invention, nor is it intended to determine the scope of the claimed matter. It is a general explanation of the benefits, intended uses, and possible embodiments of the invention contained herein.

### BRIEF DESCRIPTION OF DRAWINGS

FIG. 1 of the drawings is a perspective view of an instrumentalist using an instrument support in accordance with this invention.

FIG. 2 of the drawings is a perspective detailed view of an instrument support in accordance with this invention.

FIG. 3 of the drawings is a perspective view of an instrument support from above as it lays flat.

FIG. 4 of the drawings illustrates use of an angular adjustment mechanism of a support in accordance with this invention.

FIG. 5 of the drawings illustrates use of a vertical adjustment mechanism of a support in accordance with this invention.

FIG. 6 of the drawings illustrates use of a horizontal adjustment mechanism of a support in accordance with this invention.

FIG. 7 of the drawings is a perspective detailed view of a first magnetic member and a leg support member adjustment mechanism in accordance with this invention.

FIG. 8 of the drawings is a perspective view of an instrument support attached to a stringed instrument in accordance with this invention.

FIG. 9 of the drawings is a 3 dimensional view of an instrument support in accordance with this invention.

FIG. 10 of the drawings is a perspective embodiment of a support illustrating a rigid leg support member in place of a flexible leg support member in accordance with this invention.

FIG. 11 of the drawings is a perspective embodiment of a support illustrating a second adjustable rigid support member in accordance with this invention.

FIG. 12 of the drawings is a perspective embodiment of a support illustrating a rigid leg support member, a toothed clutch mechanism, and a spring-type engaging mechanism for said clutch in accordance with this invention.

FIG. 13 of the drawings is a perspective embodiment of a support illustrating a rigid support member, a toothed clutch mechanism, and a screw-type engaging mechanism for said clutch in accordance with this invention.

FIG. 14 of the drawings is a semi-transparent detailed view of a toothed clutch mechanism in accordance with this invention.

FIG. 15 of the drawings illustrates the rotation of a rigid leg support member about an axis in accordance with this invention.

### DETAILED DESCRIPTION OF DRAWINGS

It has been illustrated that an instrument support that can be attached to the instrument using magnets or magnetic material and is adjustable by three discrete mechanisms may be provided in accordance with this invention. These figures represent several possible embodiments of the invention and are not meant as an exhaustive representation of all possible designs.

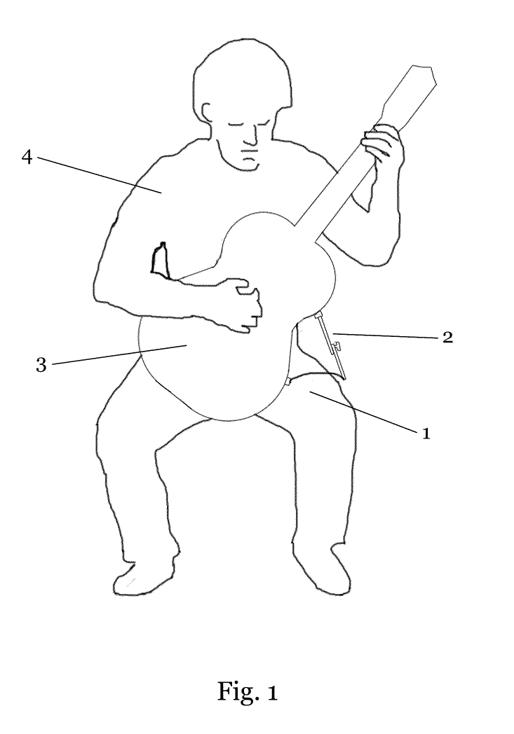

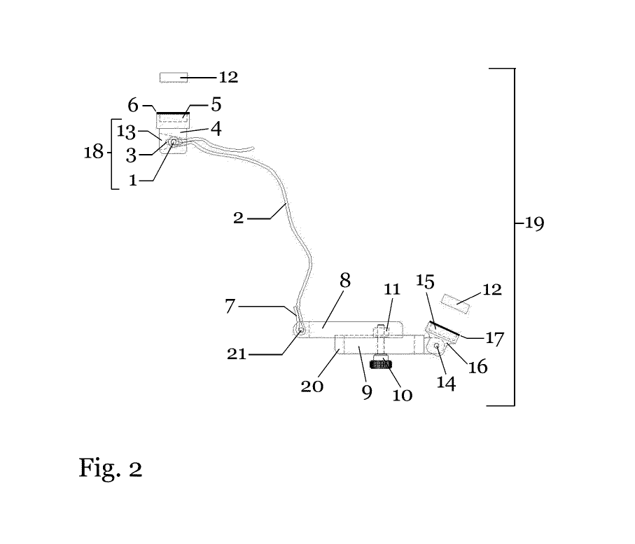

FIG. 1 of the drawings illustrates an instrumentalist (4) in sitting position playing an instrument (3) with an instrument support (2) in accordance with this invention. A support (2) is attached to an instrument (3) and rests on a player's leg (1). A support (2) will be described in further detail with reference to FIG. 2.

FIG. 2 of the drawings is a lateral, semi-transparent view of a support. A support (19) is comprised of a flexible, slip-resistant leg support member (2) attached to a first magnetic member (4) on one end and a first rigid support member (8) on the opposing end. The flexibility of a leg support member (2) allows a support to be easily collapsed and stored and also allows maximum comfort for a user. A housing (4) comprises a soft, non-corrosive, and slip-resistant material (6) that separates a housing (4) from an instrument. A material (6) is a protective barrier between an instrument and a housing (4) and also ensures continuous proper placement of a support (19) while attached to an instrument. A housing (4) also contains a magnet(s) or magnetic material (5) that attract other magnet(s) or magnetic material (12) that are installed in or on the side of an instrument. A housing (4) is also comprised of an adjustment mechanism (18) that allows the length of a leg support member (2) to be adjusted. Adjusting the length of a leg support member (2) alters the vertical positioning of an instrument while attached to a support (19). An adjustment mechanism (18) is comprised of a machined void (13), a channel (3), and a securing pin or similar member (1) that is free to move along the length of a channel (3) when a mechanism is not in a secured state. A leg support member (2) is inserted between a securing pin (1) and magnet housing (4). A leg support member (2) then envelopes a securing pin (1), and exits a housing (4). An adjustment mechanism (18) secures a leg support member (2) when force is applied to a securing pin (1), thereby moving it along a channel (3) toward the majority portion of an instrument support (19) until a leg support member (2) is fixed between a securing pin (1) and a magnet housing (4). A leg support member (2) is unsecured using force to move a securing pin (1) along a channel (3) away from the majority portion of a support (19). A leg support member (2) passes through a slot or similar component (21) in a first rigid support member (8) and is affixed back on to itself (7). It is obvious that many options for securing a leg support member (2) to a first rigid support (8) exists. A second rigid support member (20) is machined to form a channel (9) allowing the overall total length of a first rigid support (8) and second rigid support (20) to be increased or decreased. Adjusting the overall length of a first rigid support (8) and second rigid support (20) will alter the angle of the instrument in relation to an assumed horizontal plane. The overall length of a first rigid support (8) and second rigid support (20) is secured with a threaded male member (10) that is inserted into a threaded female member (11) in a first rigid support (8). It is obvious that these members can be reversed so that a threaded male member is attached to a first rigid support (8) and is accepted by a female member on a second rigid support (20). A hinge or similar mechanism (14) connects a second magnetic member (16) to a second rigid support member (20). A second magnetic member (16) comprises a soft, non-corrosive, and slip-resistant material (17) that separates a housing (16) from the instrument. The material (17) is a protective barrier between the instrument and a housing (16) and also ensures continuous proper placement of a support (19) while attached to the instrument. A housing (16) also contains a magnet(s) or magnetic material (15) that attract other magnet(s) or magnetic material (12) that are installed in or on the side of the instrument. A hinge (14) allows a second magnetic member (16) to adopt any curve on the side of the instrument thus allowing unlimited horizontal positioning of a support on the instrument

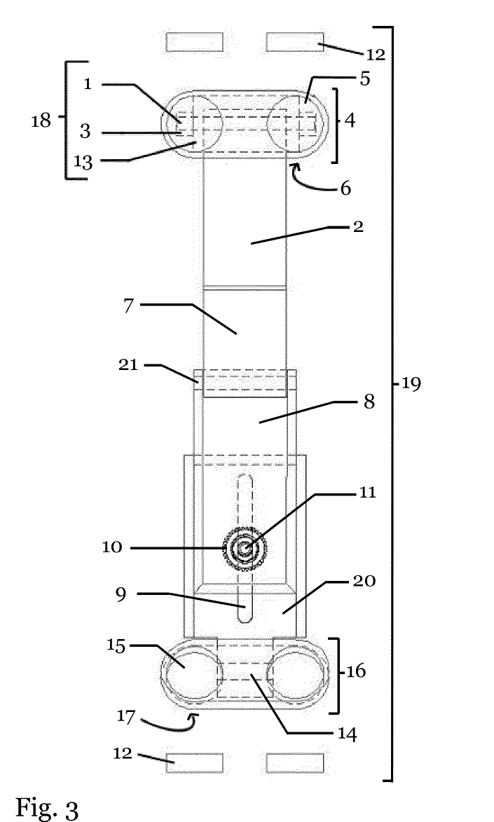

FIG. 3 of the drawings is a semi-transparent view of an instrument support member viewed from above as it lays flat. All components, members, mechanisms, and features visible in FIG. 2 (1-20) are duly illustrated in this view. A first magnetic member (4) is attached to a leg support member (2), which is attached to a first rigid support member (8), which is attached to a second rigid support member (20), which is hinged to a second magnetic member (16). A machined channel (9) in a second rigid support (20) is clearly visible from this perspective.

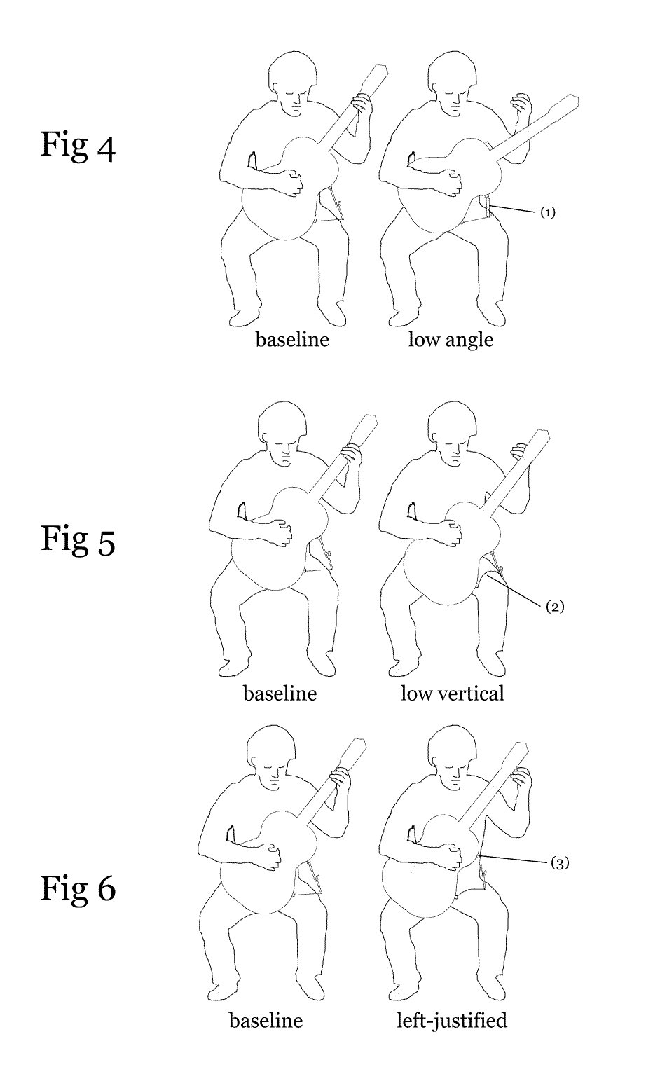

FIG. 4 of the drawings illustrates use of an angular adjustment mechanism of a support. Adjusting the length of a first and second support member (1) will alter the angular position of an instrument in relation to an assumed horizontal plane.

FIG. 5 of the drawings illustrates use of a vertical adjustment mechanism of a support. Adjusting the length of a leg support member (2) will alter the vertical position of an instrument vis-à-vis a user.

FIG. 6 of drawings illustrates use of a horizontal adjustment mechanism of a support. Adjusting the longitudinal position of a support on the underside of a guitar will alter the horizontal position of an instrument vis-à-vis a user. A pivoting attachment member (3) allows for this adjustment.

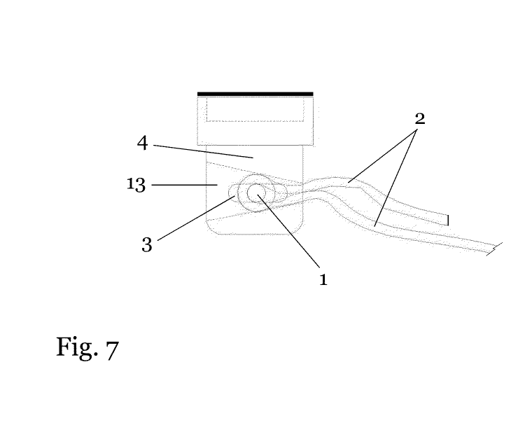

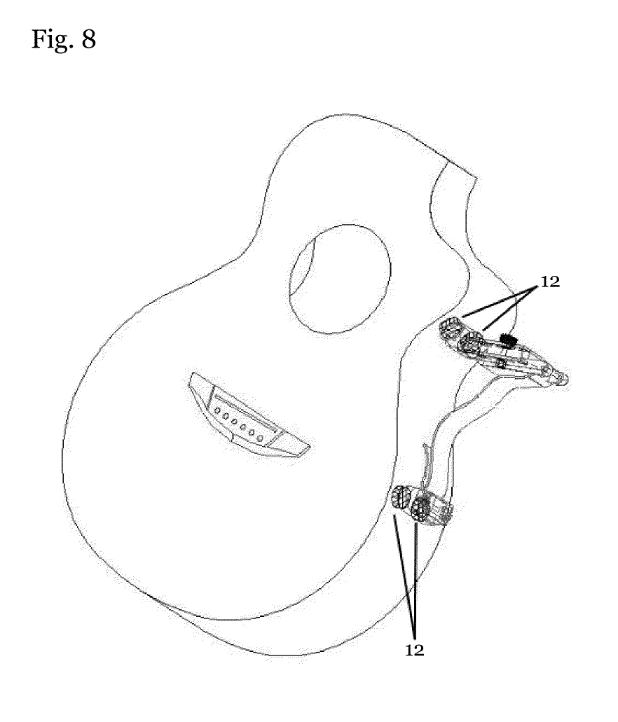

FIG. 7 of the drawings illustrates a detailed semi-transparent view of a first magnetic member (4). A leg support member (2) is secured in a machined void (13) when a securing pin or similar member (1) is forced along the length of a channel (3) toward the majority portion of a support and is fixed between a magnet housing (4) and a securing member (1).

FIG. 8 of the drawings is a semi-transparent perspective view of an instrument support attached to an instrument. An internal magnet(s) or magnetic material (12) affixed on or in an instrument is visible.

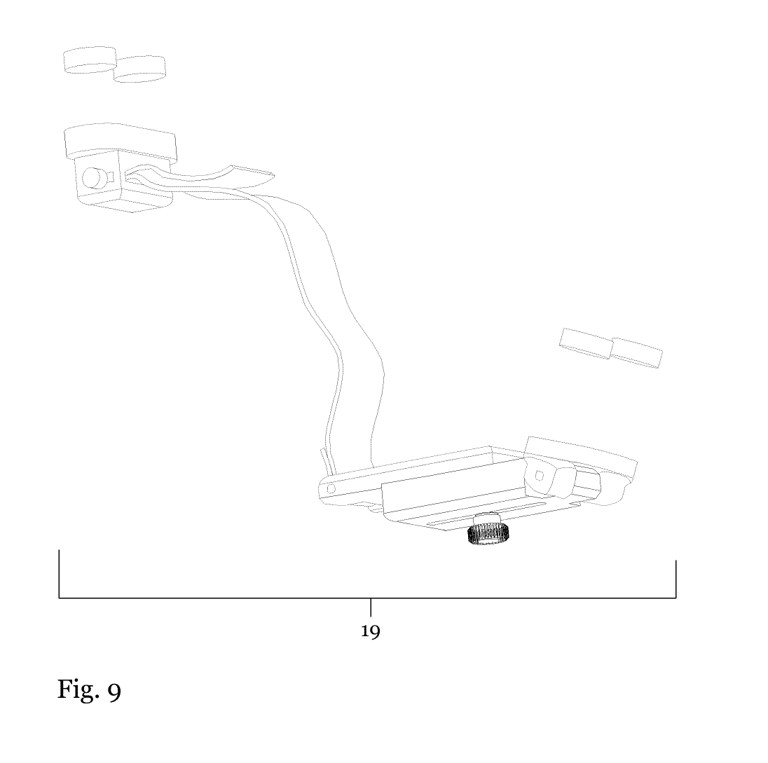

FIG. 9 of the drawings is a 3-dimensional view of a guitar support (19). An internal magnet(s) or magnetic material is not visible.

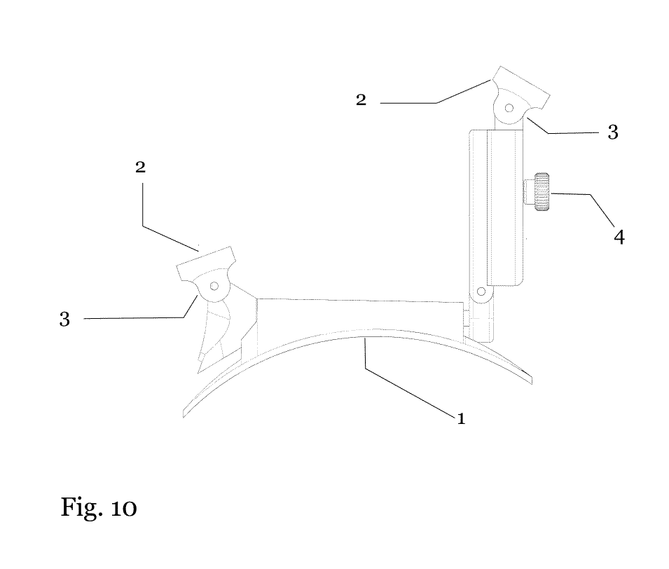

FIG. 10 of the drawings is a lateral view of a support implementing a rigid leg support member (1) in place of a flexible leg support member illustrated in FIG. 2 (2). Several components and mechanisms for this embodiment are identical to FIG. 2 (5, 6, 8, 9, 10, 11, 12, 14, 15, 16, 17, 20) but are not illustrated here for simplicity. Key features such as a magnet housing (2), magnet housing hinge (3), and securing member for an adjustable rigid support (4) are illustrated as references.

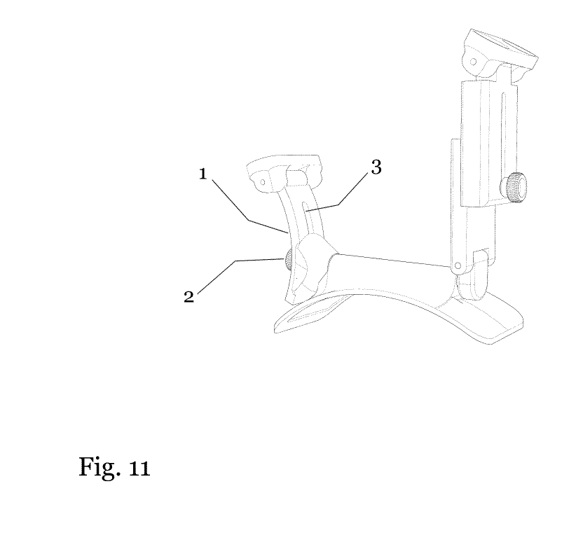

FIG. 11 of the drawings is a 3 dimensional view of a guitar support implementing an adjustable curved support member (1), an adjustment channel (3), and a securing threaded member (2). The effective length of said adjustable curved support member (1) is adjusted by loosening said securing member (2) and passing it along a machined channel (3) in said curved support member (1). Once a desired placement is achieved a securing member (2) is tightened. Adjusting said curved support member (1) will alter the height of the instrument while in playing position. The methodology for adjusting the length of said curved support member (1) member is similar to adjusting a second adjustable rigid support in FIG. 2 (20).

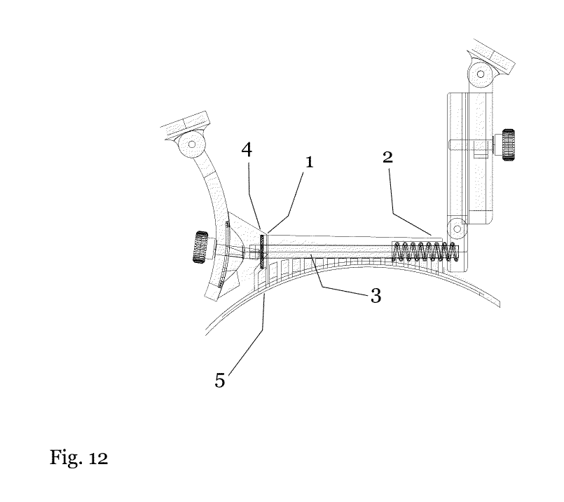

FIG. 12 of the drawings is a semi-transparent view of a support implementing a rotating rigid leg support member (5). A first (1) and second (4) toothed securing member, collectively referred to as a toothed clutch, are disengaged by compressing a spring (2). Once a toothed clutch (1, 4) is disengaged a rigid leg support member (5) is free to rotate about an axis member (3). A spring (2) is released to engage a toothed clutch (1, 4) and said rigid leg support member (5) is secured. Rotating a leg support member (5) allows it to rest with maximum contact area on a player's leg thereby increasing comfort.

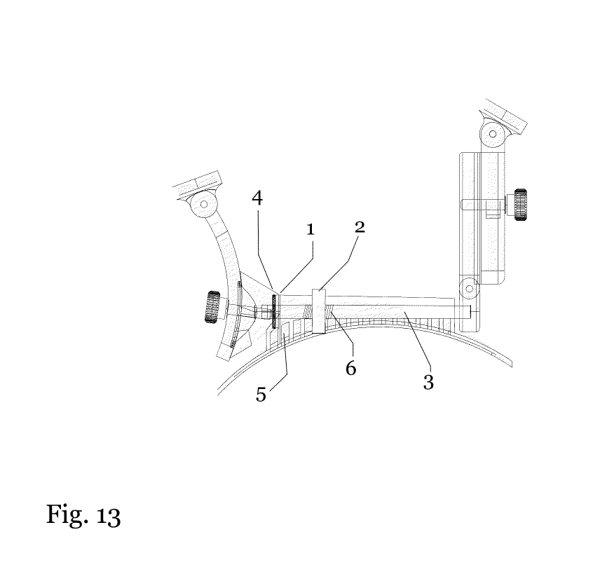

FIG. 13 of the drawings is a semi-transparent view of a support implementing a rotating rigid leg support member (5). A first (1) and second (4) toothed securing member, collectively referred to as a toothed clutch, are disengaged by loosening a female threaded member (2) affixed on a male threaded portion (6) of an axis member (3). Once a toothed clutch (1, 4) is disengaged a rigid leg support member (5) is free to rotate about an axis member (3). A threaded female member (2) is tightened to engage a toothed clutch (1, 4) and said rigid leg support member (5) is secured. Rotating a leg support member (5) allows it to rest with maximum contact area on a player's leg thereby increasing comfort.

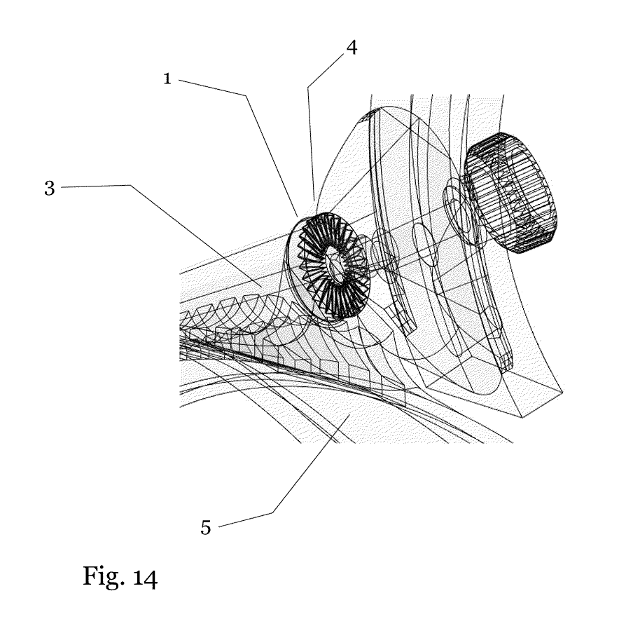

FIG. 14 of the drawings is a semi-transparent and detailed view of a fully engaged toothed clutch. Once a first (1) and second (4) toothed securing member are disengaged a rigid leg support member (5) is free to rotate about an axis member (3).

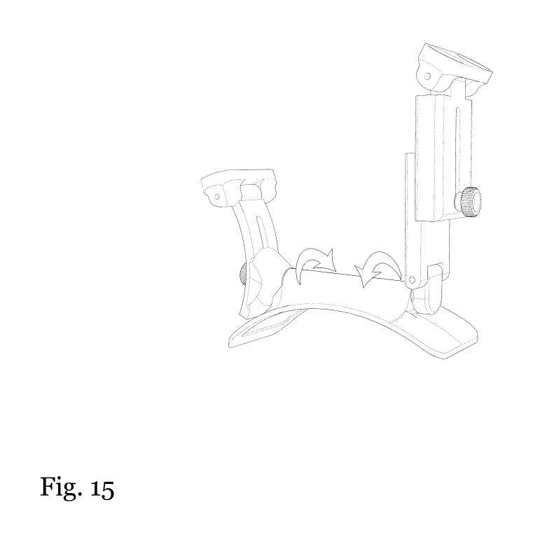

FIG. 15 of the drawings illustrates a rigid leg support member's direction of rotation about an axis when a toothed clutch is disengaged. Embodiments for engagement mechanisms are not illustrated.

That which is claimed is:

1. A device for maintaining an orientation of a musical instrument comprising:
an elongated leg support member having first and second ends;
said elongated leg support further having a leg support surface between said first and said second ends configured to maintain contact along its length with the contours of a human leg;
a first magnetic member comprising at least one magnet or magnetic material, wherein said first magnetic member is attached to said first end of said elongated leg support member, and wherein said first magnetic member further comprises a first instrument support surface;
a first remote magnetic member comprising at least one remote magnet or remote magnetic material, wherein said first remote magnetic member is configured to be affixed to a stringed musical instrument;
wherein said first magnetic member is magnetically attracted to said first remote magnetic member such that, whenever said first magnetic member is deployed in proximity to said first remote magnetic member with said instrument support surface facing said first remote magnetic member, said first magnetic member will remain in a static position relative to said first remote magnetic member.

2. The device according to claim 1 wherein said elongated leg support member is flexible.

3. The device according to claim 2 further comprising a first rigid support member affixed to said first end, wherein said first rigid support member attaches said flexible elongated leg support member to said first magnetic member.

4. The device according to claim 3 wherein said first rigid support member is adjustable in length.

5. The device according to claim 4 wherein said adjustable first rigid support member is secured by a threaded member.

6. The device according to claim 2, further comprising a hinge or like mechanism, wherein said hinge or like mechanism attaches said first magnetic member to said flexible elongated leg support member.

7. The device according to claim 2, wherein said first magnetic member further comprises a slip-resistant material affixed to said first instrument support surface.

8. The device according to claim 2, further comprising a second magnetic member comprising at least one magnet or magnetic material, wherein said second magnetic member is attached to said second end of said elongated leg support member, and wherein said second magnetic member further comprises a second instrument support surface;
a second remote magnetic member comprising at least one remote magnet or remote magnetic material, wherein said second remote magnetic member is configured to be affixed to a stringed musical instrument;
wherein said second magnetic member is magnetically attracted to said second remote magnetic member whenever said second magnetic member is deployed in proximity to said second remote magnetic member with said second instrument support surface facing said second remote magnetic member, said second magnetic member will remain in a static position relative to said second remote magnetic member.

9. The device according to claim 8 wherein said second magnetic member comprises an adjustment mechanism allowing the length of said flexible elongated leg support member to be adjusted and secured;
wherein said flexible elongated leg support member enters said second magnetic member through a first side, envelopes a securing member, and exits said second magnetic member through said first side;
wherein said securing member travels along a length of a channel and secures said flexible elongated leg support member against said second magnetic member and said securing member;
wherein a slip-resistant material is affixed to an attracting side of said second magnetic member.

10. The device according to claim 1 wherein said elongated leg support member is non-flexible.

11. The device according to claim 10 further comprising a first rigid support member affixed to said first end, wherein said first rigid support member attaches said non-flexible elongated leg support member to said first magnetic member.

12. The device according to claim 11 wherein said first rigid support member is adjustable in length.

13. The device according to claim 12 wherein said adjustable first rigid support member is secured by a threaded member.

14. The device according to claim 10, further comprising a hinge or like mechanism, wherein said hinge or like mechanism attaches said first magnetic member to said non-flexible elongated leg support member.

15. The device according to claim 10, wherein said first magnetic member further comprises a slip-resistant material affixed to said first instrument support surface.

16. The device according to claim 10, further comprising a second magnetic member comprising at least one magnet or magnetic material, wherein said second magnetic member is attached to said second end of said elongated leg support member, and wherein said second magnetic member further comprises a second instrument support surface;
a second remote magnetic member comprising at least one remote magnet or remote magnetic material, wherein said second remote magnetic member is configured to be affixed to a stringed musical instrument;
wherein said second magnetic member is magnetically attracted to said second remote magnetic member whenever said second magnetic member is deployed in proximity to said second remote magnetic member with said second instrument support surface facing said second remote magnetic member, said second magnetic member will remain in a static position relative to said second remote magnetic member.

17. The device according to claim 16 wherein a second rigid support member affixed at said second end joins said non-flexible elongated leg support member and said second magnetic member;

18. The device according to claim 17 wherein said second rigid support member is adjustable in length.

19. The device according to claim 18 wherein said adjustable second rigid support member is secured by a threaded member.

20. The device according to claim 10 wherein said non-flexible leg support member comprises a rigid axis member.

21. The device according to claim 20 wherein said non-flexible leg support member rotates in relation to said rigid axis member.

22. The device according to claim 21 wherein a toothed clutch mechanism secures said rotating non-flexible leg support member in a fixed orientation.

23. The device according to claim 22 wherein a spring or like mechanism engages said toothed clutch mechanism.

24. The device according to claim 22 wherein said rigid axis member has a male threaded portion and an accordant female threaded member engages said toothed clutch mechanism.
